(19) United States
(12) Patent Application Publication
(10) Pub. No.: US 2026/0268106 A1
(43) Pub. Date: Sep. 10, 2026

(54) SHEETSIDE POST-PROCESSING MECHANISM

(71) Applicant: Justin Coulter, Boulder, CO (US)

(72) Inventor: Justin Coulter, Boulder, CO (US)

(73) Assignee: Ricoh Company, Ltd., Tokyo (JP)

(21) Appl. No.: 19/074,811

(22) Filed: Mar. 10, 2025

(51) Int. Cl. G06K 15/02; G06K 15/12

(52) U.S. Cl. CPC G06K 15/1881; G06K 15/1223

(57) ABSTRACT

A printing system is disclosed. The printing system includes at least one physical memory device to store print control logic and one or more processors coupled with the at least one physical memory device to execute the print control logic to receive an image file including a plurality of print objects comprising a first set of print objects and a second set of print objects, wherein each of the first set of print objects being first processed objects and associated with an object tag identifier (OTI), first process the second set of print objects to generate a partial processed image file, generate a first halftoned bitmap by halftoning the first processed print objects and the partial processed image file, determine whether second processing is enabled and perform the second processing of the first halftoned bitmap to generate a final halftone bitmap upon determining that the second processing is enabled.

### FIELD OF THE INVENTION

The invention relates to the field of printing systems, and in particular, to processing print images.

### BACKGROUND

In a variety of document presentation systems such as printing systems, it is common to process (e.g., interpret and rasterize) print data to generate a bitmap representation of each sheetside image of the document by processing a sequence of print objects. The print objects (or print elements) are typically included in a print job that is defined in a page description language (PDL) or other suitable encoding that are, at some point prior to writing to a bitmap, represented as regions of rectangles of pixels.

### SUMMARY

In one embodiment, a printing system is disclosed. The printing system includes at least one physical memory device to store print control logic and one or more processors coupled with the at least one physical memory device to execute the print control logic to receive an image file including a plurality of print objects comprising a first set of print objects and a second set of print objects, wherein each of the first set of print objects being first processed objects and associated with an object tag identifier (OTI), first process the second set of print objects to generate a partial processed image file, generate a first halftoned bitmap by halftoning the first processed print objects and the partial processed image file, determine whether second processing is enabled and perform the second processing of the first halftoned bitmap to generate a final halftone bitmap upon determining that the second processing is enabled.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2 is a block diagram illustrating one embodiment of a print controller;

FIG. 3 illustrates one embodiment of a sheetside processing module;

FIG. 4 illustrates one embodiment of a post processing module;

FIG. 5 is a flow diagram illustrating one embodiment of processing a sheetside image; and

FIG. 6 illustrates one embodiment of a computer system.

### DETAILED DESCRIPTION

A mechanism to perform post-processing on sheet image print objects is described. In the following description, for the purposes of explanation, numerous specific details are set forth to provide a thorough understanding of the present invention. According to on embodiment, the mechanism receives an image file including a plurality of print objects comprising a first set of print objects and a second set of print objects, wherein each of the first set of print objects being first processed objects and associated with an object tag identifier (OTI), first processes the second set of print objects to generate a partial processed image file, generates a first halftoned bitmap by halftoning the first processed print objects and the partial processed image file, determines whether second processing is enabled and performs the second processing of the first halftoned bitmap to generate a final halftone bitmap upon determining that the second processing is enabled. One resulting technical benefit is efficient first and second processing of image files.

It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, “calculator” and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

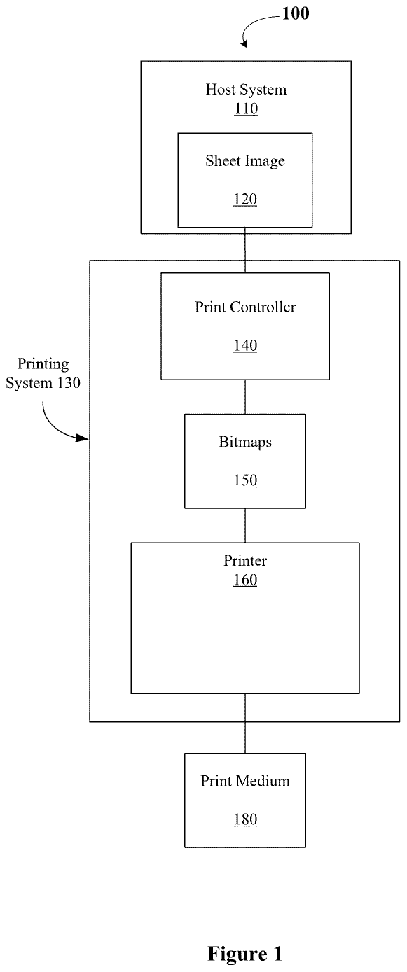

FIG. 1 illustrates one embodiment of a printing system 100. Printing system 100 includes a host system 110 and a printing system 130. Host system 110 is in communication with the printing system 130 to print a sheet image 120 onto a print medium 180 (e.g., paper) via a printer 160. The resulting print medium 180 may be printed in color and/or in any of a number of gray shades, including black and white (e.g., Cyan, Magenta, Yellow, and blacK, (CMYK)). The host system 110 may include any computing device, such as a personal computer, a server, cloud infrastructure, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for printing to the print medium 180 via the printer 160.

The printing system 130 may be a high-speed printer operable to print relatively high volumes (e.g., greater than 100 pages per minute). The print medium 180 may be continuous form paper, cut sheet paper, and/or any other tangible medium suitable for printing. The printing system 130, in one generalized form, includes the printer 160 having one or more print engines to present the bitmap 150 onto the print medium 180 via marking material (e.g., toner, ink, coatings, etc.) based on the sheet image 120.

Print controller 140 and printer 160 may both be implemented in the same printing system 130 or implemented separately and coupled together. In another embodiment, print controller 140 may be implemented in host system 110 and coupled to printer 160. Print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities.

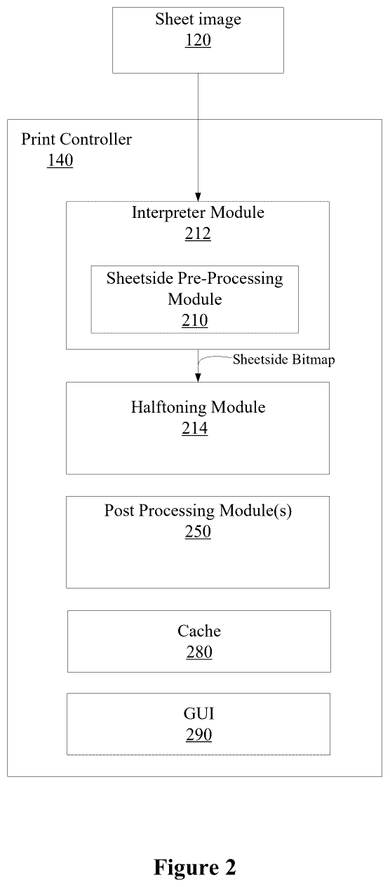

FIG. 2 illustrate one embodiment of a print controller 140. As shown in FIG. 2, print controller 140 (e.g., DFE or digital front end), in its generalized form, includes interpreter module 212, halftoning module 214, post processing module 250 and a cache 280. Interpreter module 212 is operable to process a print job. In one embodiment, interpreter module 212 print job processing comprises interpreting, rendering, rasterizing, or otherwise converting images (e.g., raw sheetside images such as sheet image 120) of a print job into sheetside bitmaps.

The sheetside bitmaps generated by interpreter module 212 are each a 2-dimensional array of pixels representing an image of the print job (e.g., a Continuous Tone Image (CTI)), also referred to as full sheetside bitmaps. The 2-dimensional pixel arrays are considered “full” sheetside bitmaps because the bitmaps include the entire set of pixels for the image. In one embodiment, interpreter module 212 is operable to interpret or render multiple raw sheetsides concurrently so that the rate of rendering substantially matches the rate of imaging of production print engines.

Halftoning module 214 is operable to represent the sheetside bitmaps as halftone patterns of ink. For example, halftoning module 214 may convert the pixels to halftone patterns of CMYK ink for application to the paper. A halftone design may comprise a pre-defined mapping of input pixel gray levels to output drop sizes based on pixel location. Drop size selection based on the contone value of a single pel is referred to as “Point Operation” halftoning. The drop size selection is based on the contone pel values in the sheetside bitmap. This contrasts with “Neighborhood Operation” halftoning, where multiple pels in the vicinity of the pel being printed are used to determine the drop size. Examples of neighborhood operation halftoning include the well-known error diffusion method.

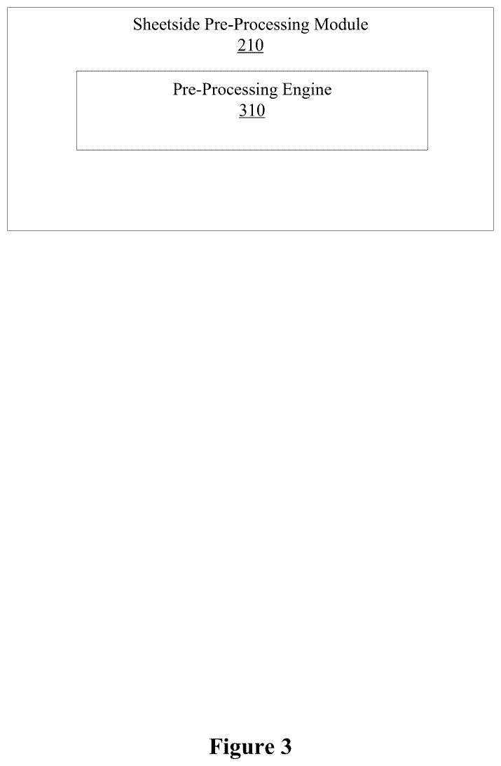

According to one embodiment, interpreter module 212 includes a sheetside pre-processing module 210 to receive a sheet image file and facilitate processing of the sheet image file. FIG. 3 illustrates one embodiment of sheetside pre-processing module 210. As shown in FIG. 3, sheetside pre-processing module 210 includes a pre-processing engine 310. Pre-processing engine 310 receives a sheet image file and facilitates the pre-processing of one or more print objects in the sheet image file, storage of the one or more pre-processed print objects into cache 280, identification of the one of more pre-processed print objects, and retrieval of the one or more print objects in the image file from cache 280. As used herein, pre-processing is also known as first processing and includes interpretation and rendering. A technical benefit of interpretation or rendering includes preparing a file for printing. As used herein, rendering refers to creating a bit map image of an input image file by assigning specific color values to each pixel in a grid of pixels.

In one embodiment, cache 280 comprises a shared memory cache that stores print objects. In such an embodiment, the cached print objects are print objects that have been previously first processed (e.g., previously interpreted and render) when encountered on a previous sheet-side. Thus, cached print objects comprise print objects that have been previously first processed (previously pre-processed print objects) and are selected to avoid interpreter module 212 which yields the technical benefit of avoiding having to re-interpret and re-render the print objects.

According to one embodiment, each print object stored in cache includes an associated object tag identifier (OTI). In such an embodiment, an OTI identifies the type of print object. In yet a further embodiment, OTIs are stored in a separate bit-plane, referred to as the Tagged Object Bit-plane. The Tagged Object Bit-plane is a N-bit plane where different object types can be identified (e.g., a 2-bit per pixel bit-plane with four print object types image, text, graphics and smooth shade). The Tagged Object Bit-plane is generated during processing (e.g., rasterization or rendering). In a further embodiment, print objects stored in cache 280 comprise a 2-bit per pixel bit bitmap of processed print objects.

In one embodiment, pre-processing engine 310 analyzes a received sheet image file and determines whether one or more of the print objects in the sheet image file are pre-processed print objects. In such an embodiment, pre-processing engine 310 searches cache 280 to determine whether one or more of the print objects in the sheet image file are stored in cache 280.

Pre-processing engine 310 further retrieves identified pre-processed print objects (e.g., first set of print objects) from cache 280. Once the cached print objects and associated OTI's are retrieved, interpreter module 212 performs first processing on the print objects in the print image file that are not pre-processed print objects (e.g., second set of print objects or vector image print objects) and bypasses performing a first process on the identified pre-processed print objects to generate a partial processed image file. As a result, interpreter module 212 first processes (e.g., interprets and renders) the not pre-processed objects in the manner discussed above.

According to one embodiment, the interpreter module 212 processing of the print objects generates a 8-bit per pixel bit bitmap of processed print objects. In this embodiment, halftone module 214 receives the partial processed image file and the pre-processed print objects and generates a halftoned bitmap for some print quality settings by using the 2-bit per pixel bit-plane bitmap when halftoning a 8-bit per pixel bit bitmap. For other print quality settings, the 2-bit per pixel bit-plane bitmap is used to directly modify a 8-bit per pixel bit bitmap prior to halftoning at halftone module 214.

Post processing module 250 receives the halftoned bitmap and performs post processing (or second processing) to generate a final halftoned bitmap. In one embodiment, post processing module 250 comprises edge enhancement module that facilitates edge enhancement processing for each pixel in the sheetside bitmap. In such an embodiment, edge enhancement processing detects edge pixels in the sheetside bitmap and performs an edge pixel specific halftoning operation on the detected pixels. However, in other embodiments, post processing module 250 may implement different types of post processing using the partial halftoned bitmap.

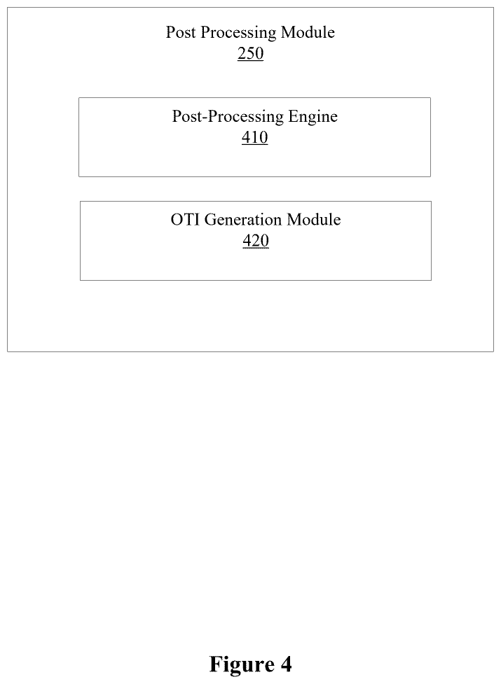

FIG. 4 illustrates one embodiment of post processing module 250 including post processing engine 410 and OTI generation module 420. Post-processing engine 410 determines whether post processing is enabled for the sheetside image. In one embodiment, post processing engine 410 determines whether post processing has been enabled. In such an embodiment, print processing may be enabled in user configuration information selected via a graphical user interface (GUI) 290 (FIG. 2) or instructed in a print job or job ticket. For example, enabling edge enhancement (e.g., to reduce jagged edges in halftoned text characters) may be supported by post-processing module 250 and requested/enabled by a user. This information is included in the job printing instructions that indicates whether post processing has been selected.

According to one embodiment, post processing engine 410 uses the first halftoned bitmap as a final halftone bitmap upon determining that the post-processing is not enabled. A resulting technical benefit includes avoiding unnecessary processing. In a further embodiment, post processing engine 410 facilitates the generation of an OTI for each print object that was in the partial processed image file (e.g., non-stored print objects) at OTI generation module 420. In such an embodiment, OTI generation module 420 generates an OTI for the non-pre-processed print objects using information received during generation of a cached object.

In one embodiment, the data of each output plane is rendered as one or more bitmaps upon generation of a cached object. In this embodiment, the RIP generates an OTI for each marked pixel, which is then mapped to one of four object types (e.g., Text=X‘01’) and an equivalent 2-bit per pixel bit written into the final OTI plane bitmap. In a further embodiment, there is one 2 bpp OTI plane/bitmap corresponding to 1. . . N output planes per sheet-sides/surface that is applied to each bitmap for a post-processing module 250.

OTI generation module 420 stores the generated OTIs in cache 280 as pre-processed print objects. Subsequently, post processing engine 410 facilitates generation of the final halftoned bitmap at halftone module 214 based on the retrieved OTIs and the generated OTIs.

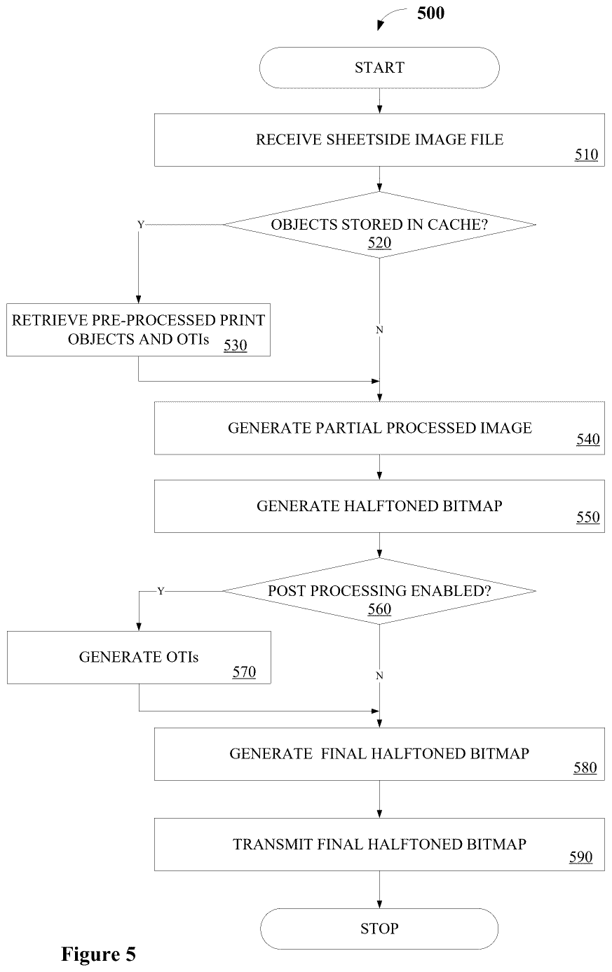

FIG. 5 is a flow diagram illustrating one embodiment of a process 500 for processing a sheetside image. Process 500 may be performed by processing logic that may comprise hardware (e.g., circuitry, dedicated logic, programmable logic, etc.), software (such as instructions run on a processing device), or a combination thereof. In one embodiment, process 500 may be performed by print controller 140. The process 500 is illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1-4 are not discussed or repeated here.

Process 500 begins at processing block 510, where a sheetside image file is received in print data to be printed. At decision block 520, a determination is made as to whether one or more print objects in the sheetside image file are pre-processed print objects (e.g., stored in cache). If so, the pre-processed print objects and their associated OTIs are retrieved from cache, processing block 530. Subsequently, or upon a determination at decision block 520 that there are no pre-processed print objects, the non-stored (e.g., non-cached) print objects are processed (e.g., interpreted and rendered) to generate a partial processed image file, processing block 540.

At processing block 550, a halftoned bitmap is generated based on the pre-processed print objects and the partial processed image file by halftoning the pre-processed print objects and the partial processed image file. At decision block 560, a determination is made as to whether post processing has been enabled. If so, OTIs are generated for print objects in the partial processed image file, processing block 570. A resulting technical benefit includes selective OTI generation to minimize computational burden. At processing block 580, a final halftoned bitmap is generated based on the retrieved OTIs and the generated OTIs by performing the post processing (e.g., second processing) on the halftoned bitmap using the retrieved OTIs and the generated OTIs. A resulting technical benefit includes tailoring the second processing based on OTI's. However, upon a determination at decision block 560 that post processing is not enabled, the halftoned bitmap generated at processing block 550 is (e.g., is designated) the final halftoned bitmap (e.g., post processing of the halftoned bitmap is bypassed) at processing block 580. At processing block 590, the final halftoned bitmap may be stored or transmitted for printing at printer 160.

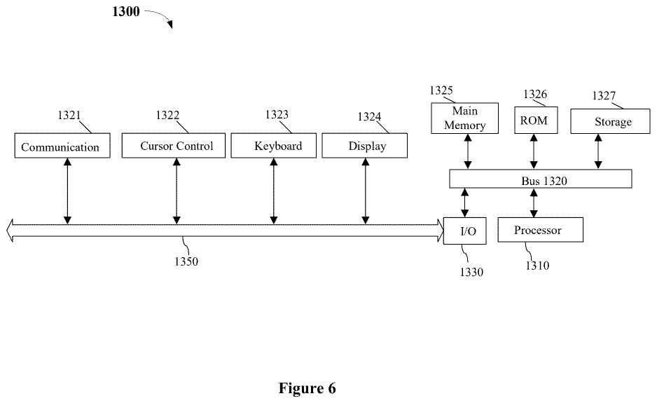

FIG. 6 illustrates a computer system 1300 on which printing host 110, printing system 130, and/or print controller 140 may be implemented. Computer system 1300 includes a system bus 1320 for communicating information, and a processor 1310 coupled to bus 1320 for processing information.

Computer system 1300 further comprises a random access memory (RAM) or other dynamic storage device 1325 (referred to herein as main memory), coupled to bus 1320 for storing information and instructions to be executed by processor 1310. Main memory 1325 also may be used for storing temporary variables or other intermediate information during execution of instructions by processor 1310. Computer system 1300 also may include a read only memory (ROM) and/or other static storage device 1326 coupled to bus 1320 for storing static information and instructions used by processor 1310.

A data storage device 1327 such as a magnetic disk or optical disc and its corresponding drive may also be coupled to computer system 1300 for storing information and instructions. Computer system 1300 can also be coupled to a second I/O bus 1350 via an I/O interface 1330. A plurality of I/O devices may be coupled to I/O bus 1350, including a display device 1324, an input device (e.g., a keyboard 1323 (e.g., alphanumeric input device) and or a cursor control device 1322). The communication device 1321 is for accessing other computers (servers or clients). The communication device 1321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a printing system comprising at least one physical memory device to store print control logic and one or more processors coupled with the at least one physical memory device to execute the print control logic to receive an image file including a plurality of print objects comprising a first set of print objects and a second set of print objects, wherein each of the first set of print objects being first processed objects and associated with an object tag identifier (OTI), first process the second set of print objects to generate a partial processed image file, generate a first halftoned bitmap by halftoning the first processed print objects and the partial processed image file, determine whether second processing is enabled and perform the second processing of the first halftoned bitmap to generate a final halftone bitmap upon determining that the second processing is enabled.

Example 2 includes the subject matter of Example 1, wherein the second processing the image file comprises generating an OTI for each print object in the second set of the plurality of print objects.

Example 3 includes the subject matter of Examples 1 and 2, wherein the second processing the image file further comprises generating the final halftoned bitmap based on the first set of print object OTIs and the generated OTIs.

Example 4 includes the subject matter of Examples 1-3, wherein the print control logic generates the final halftone bitmap based on the first halftoned bitmap upon determining that the second processing is not enabled.

Example 5 includes the subject matter of Examples 1-4, wherein first processing the second set of print objects comprises rendering the second set of print objects.

Example 6 includes the subject matter of Examples 1-5, wherein first processing the second set of print objects further comprises interpreting the second set of print objects.

Example 7 includes the subject matter of Examples 1-6, further comprising a cache memory to store the first set of print objects.

Example 8 includes the subject matter of Examples 1-7, wherein the first set of print objects comprise print objects first processed in a previous image file.

Example 9 includes the subject matter of Examples 1-8, wherein the first set of print objects comprise bitmap print objects and the second set of print objects comprise vector image print objects.

Example 10 includes the subject matter of Examples 1-9, wherein the second processing comprises edge enhancement.

Example 11 includes the subject matter of Examples 1-10, further comprising a printer to receive the final halftone bitmap.

Some embodiments pertain to Example 12 that includes at least one computer readable medium having instructions stored thereon, which when executed by one or more processors, cause the processors to receive an image file including a plurality of print objects comprising a first set of print objects and a second set of print objects, wherein each of the first set of print objects being first processed objects and associated with an object tag identifier (OTI), first process the second set of print objects to generate a partial processed image file, generate a first halftoned bitmap by halftoning the first processed print objects and the partial processed image file, determine whether second processing is enabled and perform the second processing of the first halftoned bitmap to generate a final halftone bitmap upon determining that the second processing is enabled.

Example 13 includes the subject matter of Example 12, wherein the second processing the image file comprises generating an OTI for each print object in the second set of the plurality of print objects.

Example 14 includes the subject matter of Examples 12 and 13, wherein the second processing the image file further comprises generating the final halftoned bitmap based on the first set of print object OTIs and the generated OTIs.

Example 15 includes the subject matter of Examples 12-14, wherein the print control logic generates the final halftone bitmap based on the first halftoned bitmap upon determining that the second processing is not enabled.

Example 16 includes the subject matter of Examples 12-15, wherein first processing the second set of print objects comprises rendering the second set of print objects.

Some embodiments pertain to Example 17 that includes a method comprising receiving an image file including a plurality of print objects comprising a first set of print objects and a second set of print objects, wherein each of the first set of print objects being first processed objects and associated with an object tag identifier (OTI), first processing the second set of print objects to generate a partial processed image file, generating a first halftoned bitmap by halftoning the first processed print objects and the partial processed image file, determining whether second processing is enabled and performing the second processing of the first halftoned bitmap to generate a final halftone bitmap upon determining that the second processing is enabled.

Example 18 includes the subject matter of Example 17, wherein the second processing the image file comprises generating an OTI for each print object in the second set of the plurality of print objects.

Example 19 includes the subject matter of Examples 17 and 18, wherein the second processing the image file further comprises generating the final halftoned bitmap based on the first set of print object OTIs and the generated OTIs.

Example 20 includes the subject matter of Examples 17-19, wherein the print control logic generates the final halftone bitmap based on the first halftoned bitmap upon determining that the second processing is not enabled.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising:
at least one physical memory device to store print control logic; and
one or more processors coupled with the at least one physical memory device to execute the print control logic to:
receive an image file including a plurality of print objects comprising a first set of print objects and a second set of print objects, wherein each of the first set of print objects being first processed objects and associated with an object tag identifier (OTI);
first process the second set of print objects to generate a partial processed image file;
generate a first halftoned bitmap by halftoning the first processed print objects and the partial processed image file;
determine whether second processing is enabled; and
perform the second processing of the first halftoned bitmap to generate a final halftone bitmap upon determining that the second processing is enabled.

2. The system of claim 1, wherein the second processing the image file comprises generating an OTI for each print object in the second set of the plurality of print objects.

3. The system of claim 2, wherein the second processing the image file further comprises generating the final halftoned bitmap based on the first set of print object OTIs and the generated OTIs.

4. The system of claim 1, wherein the print control logic generates the final halftone bitmap based on the first halftoned bitmap upon determining that the second processing is not enabled.

5. The system of claim 1, wherein first processing the second set of print objects comprises rendering the second set of print objects.

6. The system of claim 5, wherein first processing the second set of print objects further comprises interpreting the second set of print objects.

7. The system of claim 1, further comprising a cache memory to store the first set of print objects.

8. The system of claim 7, wherein the first set of print objects comprise print objects first processed in a previous image file.

9. The system of claim 7, wherein the first set of print objects comprise bitmap print objects and the second set of print objects comprise vector image print objects.

10. The system of claim 1, wherein the second processing comprises edge enhancement.

11. The system of claim 1, further comprising a printer to receive the final halftone bitmap.

12. At least one computer readable medium having instructions stored thereon, which when executed by one or more processors, cause the processors to:
receive an image file including a plurality of print objects comprising a first set of print objects and a second set of print objects, wherein each of the first set of print objects being first processed objects and associated with an object tag identifier (OTI);
first process the second set of print objects to generate a partial processed image file;
generate a first halftoned bitmap by halftoning the first processed print objects and the partial processed image file;
determine whether second processing is enabled; and
perform the second processing of the first halftoned bitmap to generate a final halftone bitmap upon determining that the second processing is enabled.

13. The computer readable medium of claim 12, wherein the second processing the image file comprises generating an OTI for each print object in the second set of the plurality of print objects.

14. The computer readable medium of claim 13, wherein the second processing the image file further comprises generating the final halftoned bitmap based on the first set of print object OTIs and the generated OTIs.

15. The computer readable medium of claim 12, wherein the print control logic generates the final halftone bitmap based on the first halftoned bitmap upon determining that the second processing is not enabled.

16. The computer readable medium of claim 12, wherein first processing the second set of print objects comprises rendering the second set of print objects.

17. A method comprising:
receiving an image file including a plurality of print objects comprising a first set of print objects and a second set of print objects, wherein each of the first set of print objects being first processed objects and associated with an object tag identifier (OTI);
first processing the second set of print objects to generate a partial processed image file;
generating a first halftoned bitmap by halftoning the first processed print objects and the partial processed image file;
determining whether second processing is enabled; and
performing the second processing of the first halftoned bitmap to generate a final halftone bitmap upon determining that the second processing is enabled.

18. The method of claim 17, wherein the second processing the image file comprises generating an OTI for each print object in the second set of the plurality of print objects.

19. The method of claim 18, wherein the second processing the image file further comprises generating the final halftoned bitmap based on the first set of print object OTIs and the generated OTIs.

20. The method of claim 17, wherein the print control logic generates the final halftone bitmap based on the first halftoned bitmap upon determining that the second processing is not enabled.
